(19) United States
(12) Patent Application Publication
(10) Pub. No.: US 2026/0340585 A1
(43) Pub. Date: Oct. 29, 2026

(54) SYSTEMS AND METHODS FOR LOCALIZED VARIABLE LOGIC IN TRANSACTIONAL AND STRUCTURED DOCUMENTS

(71) Applicant: Burt Taylor Talcott, Tacoma, WA (US)

(72) Inventor: Burt Taylor Talcott, Tacoma, WA (US)

(21) Appl. No.: 19/454,418

(22) Filed: Jan. 21, 2026

Related U.S. Application Data
(60) Provisional application No. 63/795,618, filed on Apr. 27, 2025.
(60) Provisional application No. 63/803,930, filed on May 12, 2025.
(60) Provisional application No. 63/805,993, filed on May 15, 2025.
(60) Provisional application No. 63/807,667, filed on May 18, 2025.

(51) Int. Cl. G06Q 10/10

(52) U.S. Cl. CPC G06Q 10/10

(57) ABSTRACT

A computer-implemented system enables dynamic variable-driven logic within a single transactional or structured document instance, such as a purchase order or sales quote. A local variable engine, embedded client-side, parses user-defined expressions into abstract syntax trees for efficient, cycle-free evaluation via topological sorting of dependency graphs. Users define variables in header fields and link them to line-item quantities or totals through interactive interfaces, including draggable pill-style tokens or text entry. The engine automatically computes and updates dependent fields in real-time upon changes, without external rule engines, network calls, or cross-document synchronization. Semantic prefixes (e.g., $ for monetary pools, \hat{ } for allocation counters enforcing completeness through consumption tracking, #for SKUs) guide evaluation. A Seed Model supports one-time import of preconfigured data from structured sources. An optional local AI assistant interprets natural-language inputs to suggest scoped variables and expressions, with all processing occurring in-memory.

### CROSS-REFERENCE TO RELATED APPLICATIONS

This application claims the benefit of priority under 35 U.S.C. § 119(e) to the following U.S. provisional patent applications, the entire contents of which are hereby incorporated by reference:

U.S. Provisional Patent Application No. 63/795,618, filed Apr. 27, 2025, titled Dynamic Variable Driven Multi Line Order Adjustment System and Method;

U.S. Provisional Patent Application No. 63/803,930, filed May 12, 2025, titled AI Assisted Method for Interpreting User Defined Variable Logic in Business Systems;

U.S. Provisional Patent Application No. 63/805,993, filed May 15, 2025, titled System and Method for Injecting Logic Overlays into Existing Software Interfaces; and

U.S. Provisional Patent Application No. 63/807,667, filed May 18, 2025, titled System and Method for Visual Logic Mapping and Configuration of Web Interfaces Using VE LogicMapper™.

### FIELD OF THE INVENTION

The present invention relates generally to computer-implemented systems for generating, editing, and processing transactional or structured documents. More specifically, the invention concerns localized variable logic, semantic prefix tokens, allocation counters, encapsulated logic token editors, and optional AI-assisted variable creation within a single self-contained document instance.

### BACKGROUND OF THE INVENTION

Conventional systems for creating and processing transactional documents such as sales orders and purchase orders rely on static values for quantities, totals, and pricing. Business users typically calculate relationships externally, often using spreadsheets, calculators, or manual methods. These static approaches lack:
1. Dynamic relationships between quantities and user-defined variables
2. User-defined logic accessible to non-technical users
3. Real-time recalculation when variables change
4. Transparency into how a quantity or total was derived
5. Allocation enforcement across multiple entities (e.g., ensuring each team member receives required items)
6. Adaptability to evolving business situations without developer intervention

For example, systems like those described in US10540153B2 (Spreadsheet based software application development) rely on external templates and server-side formula processing, introducing dependencies that can alter behavior unexpectedly and require network access. Similarly, tools such as Tines use “pill”-style visual elements for formula building in workflows, but lack localized evaluation within a single transactional document instance, relying instead on broader automation platforms. Other approaches, such as U.S. Pat. No. 5,590,259A (Tabbed spreadsheet interfaces), provide user-familiar objects for formula editing but do not embed semantic-guided, self-contained logic without external scripting or dependencies. Additionally, US11681510B2 (Machine learning code generation with prefixes) enables prefix-based code manipulation for ML tasks, but differs as it is not tailored to transactional documents and requires external compilation or execution environments, lacking the in-memory, single-instance localization of the present invention.

Existing software requires custom coding or scripting to implement even simple relationships, such as linking quantity to the number of participants or computing totals based on dependent inputs, often leading to inefficiencies like those in US20050050088 (Integrated spreadsheet-word tables), which add spreadsheet elements to tables but fail to enforce localized allocation or automatic propagation without external tools.

There is therefore a need for a local, self-contained, user-friendly system that:
1. Allows users to define variables and formulas directly in the document via various interfaces, such as graphical tokens or text entry, without coding
2. Supports allocation counters to ensure completeness across groups through local tracking and enforcement during propagation
3. Evaluates formulas automatically using in-memory dependency graphs
4. Updates order fields when variables change with cycle detection to prevent errors
5. Operates entirely within a single transactional document instance, avoiding the external dependencies and synchronization risks of prior systems like pill-based workflow editors
6. Supports optional AI assistance without enterprise-level automation, confined to local interpretation for privacy and efficiency.

### SUMMARY OF THE INVENTION

The invention enables dynamic, variable-driven logic within an individual transactional document instance by embedding a client-side (Node. js-compatible) engine that maintains an in-memory variable stack and dependency graph for real-time propagation, as illustrated in FIG. 1 (System Architecture). Users define variables, assign values in header fields (see FIG. 2 for document structure), and create expressions linking variables to line-item fields via a parser that converts inputs into executable ASTs, ensuring efficient computation without recursion overflows or external calls.

### Key Features Include:

A variable manager for storing and manipulating local variables as key-value pairs with semantic metadata, supporting operations like increment/decrement for counters (see pseudocode for Variable Manager below).
An expression construction mechanism for defining formulas, including embodiments using visual logic tokens (e.g., draggable pill-style tokens) and embodiments using non-visual inputs such as text entry or programmatic/serialized expression injection, wherein expressions are parsed or accepted in a structured representation for local evaluation.
A local logic evaluator that computes results without external dependencies, following topological order to handle dependencies in O(n) time (see pseudocode for Parser & Evaluator below).
Semantic prefix tokens ($, \hat{ }, #, ~, @, &) guiding variable behavior, e.g., \hat{ } for allocation counters that track consumption and flag incompleteness if total ≠ target (see pseudocode for Allocation Counter Enforcement).
A data initialization mechanism (“Seed Model”) for one-time importation of preconfigured variables from templates or structured data files (e.g., EDI, JSON), parsing input into local objects without retaining source links (see pseudocode for Seed Model).
Allocation counters (\hat{ }) enforcing completeness across multiple entities by aggregating line-item usages and providing visual alerts in the UI (see FIG. 3 for variable objects).
An optional local AI assistant interpreting natural-language inputs when explicitly triggered via @ prefixes, using an embedded model to generate proposals that integrate seamlessly into the document's logic without external calls.

This patent expressly excludes enterprise governance, centralized rule propagation, cross-document logic, remote synchronization, or live dependency. Those features are reserved for separate filings.

### BRIEF DESCRIPTION OF THE DRAWINGS

FIG. 1: System Architecture (Local Execution Environment showing External Source Import).

FIG. 2: Transactional Document Structure (User Interface showing Header vs. Line Items).

FIG. 3: User Interface/Variable Tokens (Variable Definition Objects showing $ and tokens).

FIG. 4: Logic Editor (The Logic Editor showing quantity=players * rounds).

FIG. 5: Evaluation Flowchart (The vertical flow: Identify->Determine->Resolve->Compute).

FIG. 6: Propagation Diagram (The Dependency Graph showing variable stack levels).

FIG. 7: Seed Model (The Import Flow from Origin Source to Local Document).

FIG. 8: AI Pipeline (The Input->Local AI->Suggestion flow).

FIG. 9: Line Item Example (The table showing Paintballs and Markers logic).

FIG. 10: Allocation Counter Example (The \hat{ }shoes hierarchy tree).

### DETAILED DESCRIPTION OF THE INVENTION

The present invention provides systems and methods for enabling dynamic, variable-driven logic entirely within a single transactional or structured document instance, such as a purchase order, sales order, quote, invoice, or similar document. Unlike conventional systems that rely on external spreadsheets, server-side rule engines, or cross-document synchronization, the invention operates in a local execution environment (client-side or embedded runtime), ensuring all variable instantiation, expression evaluation, and field updates occur in-memory without external dependencies. This approach eliminates network latency, enhances computational efficiency, and provides transparency and adaptability for non-technical users.

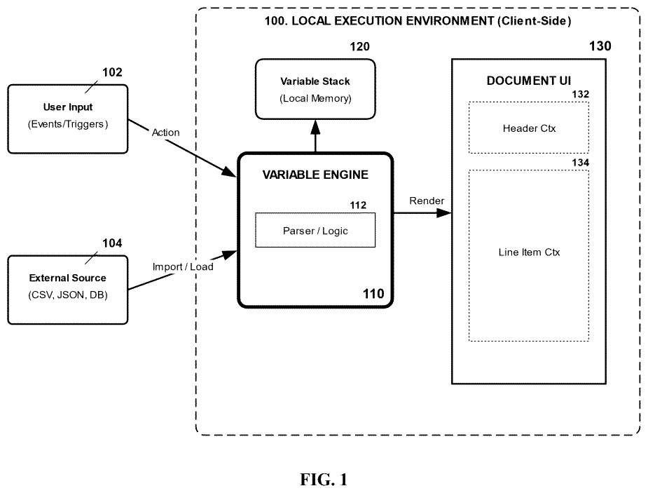

FIG. 1 illustrates the overall system architecture (100) in a local execution environment (dashed box 100), typically implemented in a browser, desktop application, or Node. js-compatible client runtime. User input (102) or external structured data sources (104, e.g., JSON, CSV, EDI) interact with a Variable Engine (110) that includes a Parser (112) for processing expressions. The engine maintains a Variable Stack (120) in local memory and updates the Document UI (130), comprising Header Context (132) and Line Item Contexts (134). All processing remains isolated to the single document instance.

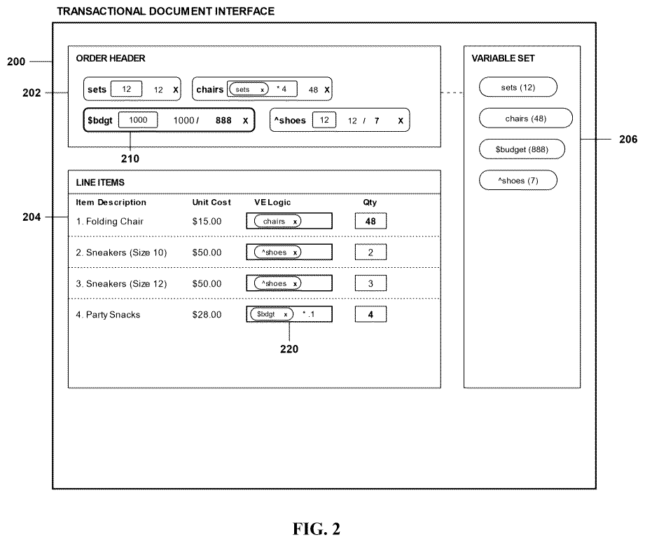

FIG. 2 depicts an exemplary transactional document interface (200). The order header (202) includes user-defined variables such as “sets” (210) and derived fields like “chairs” (linked via expression) and “$budget” (monetary pool). Line items (204) contain Variable Engine Logic fields (220) that reference variables (e.g., quantity=chairs→sets *4). A variable set panel (206) displays available variables for selection.

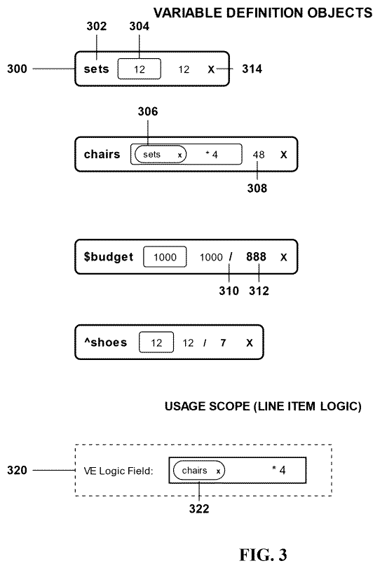

FIG. 3 shows variable definition objects (300) and their relationships. Variables like “sets” (302), “chairs” (306, with expression “sets *4”), “$budget” (310), and “\hat{ }shoes” (312, allocation counter) are stored with values, prefixes, and scopes. Line-item logic (320) applies usage scopes (322) to enforce constraints.

### Variable Engine and Variable Stack

Variables are instantiated via user input, automated parsing, or the Seed Model. Variables are stored in an in-memory stack, where each entry includes the variable's identifier, current value, and semantic metadata (e.g., prefix type and evaluation behavior). In some embodiments, a semantic prefix may be represented as part of the variable name (e.g., \hat{ }shoes, $budget) and/or stored as metadata associated with the variable, and either representation may be used provided that resolution and evaluation remain strictly local to the single transactional document instance.

Pseudocode example (JavaScript-style, implementable in a browser, Node. js runtime, or equivalent local environment):

```
// In-memory variable stack: object as key-value store with metadata for localization
// No external calls ensure all logic remains within the document instance
const variableStack = { }; // e.g., { sets: { value: 12, prefix: null, type: ‘plain’ } }
// NOTE: ‘name’ may include the semantic prefix (e.g., ‘\hat{ }shoes', ‘$budget’) and/or the
prefix may be stored in metadata; either is valid if resolved locally.
function define Variable(name, initialValue, prefix = null) {
  let metadata = { value: initialValue, prefix, type: ‘plain’, dependencies: [] };
  if (prefix === ‘\hat{ }’) { // Allocation counter: tracks consumption locally
    metadata.type = ‘counter’;
    metadata.consumed = 0;
    metadata.target = initialValue;
    metadata.remaining = initial Value;
  } else if (prefix === ‘$’) { // Monetary pool: deducts remaining balance in-memory
    metadata.type = ‘pool’;
    metadata.remaining = initialValue;
  } // Handle other prefixes (#, ~, @, &) similarly...
  variableStack[name] = metadata;
  // Register in dependency graph if expression present (local only)
}
```

Updates propagate via event listeners on variable changes, triggering re-evaluation only for dependent fields.

### Expression Parsing and Local Evaluation

Expressions (e.g., “sets * 4” or “$budget * 0.1”) are parsed into Abstract Syntax Trees (ASTs) for safe, efficient evaluation. A dependency graph tracks relationships (e.g., “chairs” depends on “sets”) and uses topological sorting to ensure cycle-free propagation.

Pseudocode example (JavaScript-style, implementable in a browser, Node. js runtime, or equivalent local environment):

```
// Simple local parser: custom or lightweight like jsep; no external dependencies
function parseExpression(exprStr) {
  // Returns AST (e.g., { type: ‘BinaryExpression’, operator: ‘*’, left: { type: ‘Identifier’,
name: ‘sets’ }, right: { type: ‘Literal’, value: 4 } })
  return localAstParser.parse(exprStr); // Implemented locally to ensure isolation
}
// Dependency graph: var → [dependent fields]; stored in-memory
const dependencyGraph = { }; // e.g., { sets: [‘chairs_qty’, ‘total_cost’] }
// Local document field model: each field may have an expression and optional metadata.
// For counters, consuming fields may declare “consumesFrom” to bind consumption to a
counter.
const documentFields = { };
// Example: documentFields[‘Size9_qty’] = { expression: ‘chairs * 1’, consumesFrom:
‘\hat{ }shoes’, value: 0 }
// Local line item map (populated from the current document instance)
// Example: lineItemsBySku[‘Bat00z’] = { qty: 5, unitPrice: 28.00, extPrice: 140.00 }
const lineItemsBySku = { };
function resolveIdentifier(name) {
  // SKU reference identifiers may dereference a local line item by SKU and field.
  // Example: “#Bat00z.qty” returns the quantity of the Bat00z line item (local-only).
  if (name.startsWith(‘#’)) {
  const token = name.slice(1); // “Bat00z.qty”
  const [sku, field = ‘qty’] = token.split(‘.’);
  const item = lineItemsBySku[sku];
  if (!item) return 0;
  if (field === ‘qty’) return Number(item.qty ?? 0);
  if (field === ‘unitPrice’) return Number(item.unitPrice ?? 0);
  if (field === ‘extPrice’) return Number(item.extPrice ?? 0);
  return 0;
  }
  // NOTE: ‘\hat{ }’ counters are not consumed on identifier read. Consumption is computed
  // from consuming fields (idempotent) each propagation pass.
  const v = variableStack[name];
  if (!v) return 0;
  // Counters may be referenced for display/logic; return target or remaining depending on
embodiment.
  if (v.type === ‘counter’) return Number(v.target ?? 0);
  if (v.type === ‘pool’) return Number(v.remaining ?? 0);
  return Number(v.value ?? 0);
}
function evaluateExpression(astNode, targetField) {
  function traverse(node) {
    if (node.type === ‘Identifier’) return resolveIdentifier(node.name);
    if (node.type === ‘Literal’) return node.value;
    if (node.type === ‘BinaryExpression’) {
      const left = traverse(node.left);
      const right = traverse(node.right);
      switch (node.operator) {
        case ‘*’: return left * right;
        case ‘+’: return left + right;
        case ‘−’: return left − right;
        case ‘/’: return right === 0 ? 0 : left / right;
      }
    }
    throw new Error(‘Unsupported AST node’);
  }
    const result = traverse(astNode);
    updateDocumentField(targetField, result); // Apply to header/line-item locally
    return result;
  }
  function propagateUpdates(changedVar) {
    // Topological sort for safe order (DFS-based); prevents cycles without external tools
    const visited = new Set( );
    const order = [ ];
    function dfs(node) {
      if (visited.has(node)) return;
      visited.add(node);
      (dependencyGraph[node] || [ ]).forEach(dfs);
      order.push(node);
    }
    dfs(changedVar);
    order.reverse( ); // Evaluation order
    for (const depField of order) {
      if (documentFields[depField]?.expression) {
        const ast = parseExpression(documentFields[depField].expression);
        const value = evaluateExpression(ast, depField);
        documentFields[depField].value = value; // retain computed value locally
    }
  }
  // After dependent fields settle, recompute counters/pools idempotently (see below).
  recomputeSemanticAggregates( );
}
```

### Semantic Prefixes and Allocation Counters

Prefixes guide evaluation behavior. For allocation counters (\hat{ }) and monetary pools ($), consumption may be tracked and enforced locally by recomputing aggregate usage from consuming fields during propagation within the single document instance.

### Semantic Prefixes and Idempotent Consumption Computation

In some embodiments, semantic prefixes alter evaluation behavior by selecting specialized local computation modes. For example, allocation counters identified by the \hat{ }prefix enforce completeness by tracking consumption of a target quantity across a plurality of fields (e.g., line-item quantities), and monetary pools identified by the $ prefix track remaining balance as amounts are allocated across a plurality of fields (e.g., extended prices or costs).

To ensure correctness during repeated re-evaluation, consumption tracking is idempotent with respect to the current document state. In such embodiments, the system does not accumulate consumption by incrementing a stored counter on each evaluation pass. Instead, the system computes consumption as a deterministic aggregate derived from the current values of the consuming fields. For example, consumed units for a \hat{ }counter may be computed as the sum of all line-item quantities, or sub-quantities, designated as consuming from that counter; and consumed amount for a $ pool may be computed as the sum of all line-item costs, extended prices, or other monetary fields designated as consuming from that pool.

After the aggregate consumed value is computed, the system computes remaining capacity (e.g., remaining=target−consumed) and generates local UI indicators when remaining is nonzero (incomplete) or negative (over-allocated). Because consumption is derived from the current document state, repeated evaluation yields the same consumed/remaining values unless the underlying consuming fields change, thereby preventing double-counting during propagation and ensuring stable, cycle-free operation within the single document instance. In a preferred embodiment, the consumed value is recomputed from consuming fields each propagation pass; the following pseudocode illustrates one possible enforcement routine, and may be implemented using either incremental tracking or recomputed aggregates.

Pseudocode example (JavaScript-style):

```
function recomputeSemanticAggregates( ) {
  // Reset counters and pools to their baseline state
  for (const [name, v] of Object.entries(variableStack)) {
    if (v.type === ‘counter’) {
      v.consumed = 0;
      v.remaining = Number(v.target ?? 0);
    } else if (v.type === ‘pool’) {
      // In some embodiments, pools track remaining by subtracting consuming amounts.
      // Reset remaining to the original balance (stored separately or reused as value/target).
      const base = Number(v.value ?? v.target ?? v.remaining ?? 0);
      v.remaining = base;
      v.consumed = 0;
    }
  }
  // Aggregate consumption from consuming fields (idempotent with respect to document
state)
  for (const field of Object.values(documentFields)) {
    const counterName = field.consumesFrom; // e.g., ‘\hat{ }shoes’ or ‘$budget’
    if (!counterName) continue;
    const agg = variableStack[counterName];
    if (!agg) continue;
    const amount = Number(field.value ?? 0);
    if (agg.type === ‘counter’) {
      agg.consumed += amount;
      agg.remaining = Number(agg.target ?? 0) - agg.consumed;
    } else if (agg.type === ‘pool’) {
      agg.consumed += amount;
      agg.remaining = Number(agg.remaining ?? 0) - amount;
    }
  }
  // Local enforcement / UI flags
  for (const [name, v] of Object.entries(variableStack)) {
    if (v.type === : ‘counter’ || v.type === ‘pool’) {
      if (v.remaining < 0) {
        console.warn(‘Over-allocation for ${name}: ${-v.remaining} over’);
      } else if (v.remaining !== 0 && v.type === ‘counter’) {
        console.warn(‘Incomplete allocation for ${name}: ${v.remaining} remaining’);
      }
    }
  }
}
```

Other prefixes may alter evaluation behavior in analogous ways, including monetary pools ($) that track remaining balance locally based on consuming fields.

### Seed Model Initialization

The Seed Model enables one-time import of structured data without ongoing dependency.

Pseudocode example (JavaScript-style):

```
function seedImport(jsonData) {
  const parsed = JSON.parse(jsonData); // Or CSV/EDI parser
  for (const [key, value] of Object.entries(parsed)) {
    defineVariable(key, value, ‘&’); // Mark as seeded snapshot
  }
  // No retained reference to source; fully local
}
```

### Expression Construction and User Interface

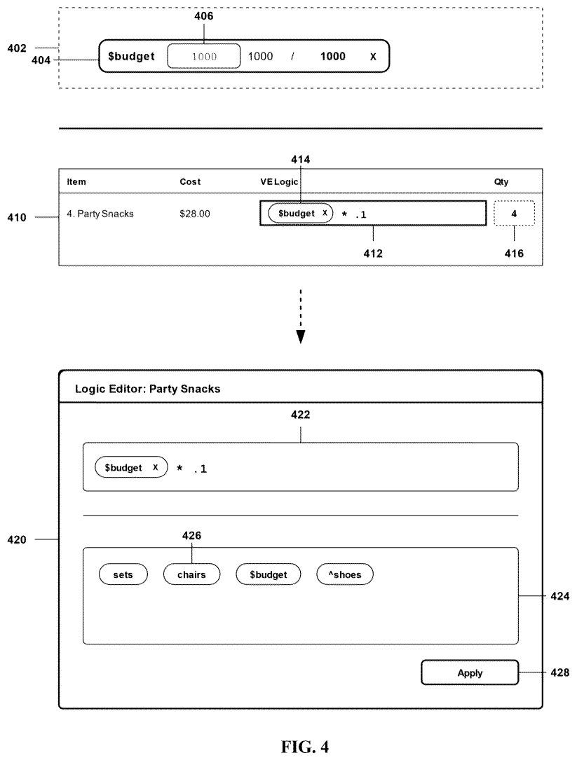

Expressions are built via text entry or optional interactive elements (e.g., draggable pill tokens as in FIG. 4). The parser converts tokens to strings/ASTs.

### Non-UI and Programmatic Expression Embodiments

Although certain embodiments provide an interactive token-based editor (e.g., pill-style tokens) to assist users in constructing expressions, the invention is not limited to any particular user interface. In alternative embodiments, expressions and variable definitions are created without graphical tokens, including via plain-text entry, structured form entry, programmatic injection, or import of a serialized token sequence or abstract syntax representation (e.g., JSON tokens, AST nodes, or another structured format). The local evaluator parses or accepts the expression representation and performs dependency resolution, cycle detection, and propagation in the same manner as token-based embodiments.

### Optional Local AI Assistant

When triggered (e.g., via @ prefix), an embedded lightweight model interprets natural language to propose variables/expressions, fully scoped locally.

### Error Handling and Edge Cases

The system includes mechanisms for handling errors and edge cases to ensure robustness. For example, if a cycle is detected in the dependency graph during topological sorting (e.g., variable A depends on B, B on C, C on A), the evaluator alerts the user via a UI notification and prevents propagation to avoid infinite loops. Similarly, invalid expressions (e.g., malformed syntax or undefined variables) trigger parsing errors with suggestions for correction. For semantic prefixes, invalid usage (e.g., over-consumption in \hat{ }counters or negative balances in $ pools) raises exceptions that display contextual alerts, such as “Allocation exceeded—adjust quantities.” These features operate entirely locally, without external logging or recovery systems.

### Alternative Embodiments

The invention may be implemented in browser extensions, desktop apps, or mobile runtimes. Variations include different parsers or UI paradigms while preserving localization.

While specific embodiments have been described, the invention is not limited thereto. The scope is defined by the claims.

### 4. Local Expression System (FIG. 4)

Expressions govern how quantities, prices, totals, and other values are derived. Expressions may be constructed using an encapsulated logic token editor (420) where each token (426) represents a variable, operand, operator, or literal. The system ensures each token is clearly represented and may be manipulated by clicking, dragging, or typing.

Users may enter expressions in either header fields (402) or line-item fields (410). The system parses the expression (422) into an internal representation (e.g., abstract syntax tree or JSON token graph) and computes its result using only local data.

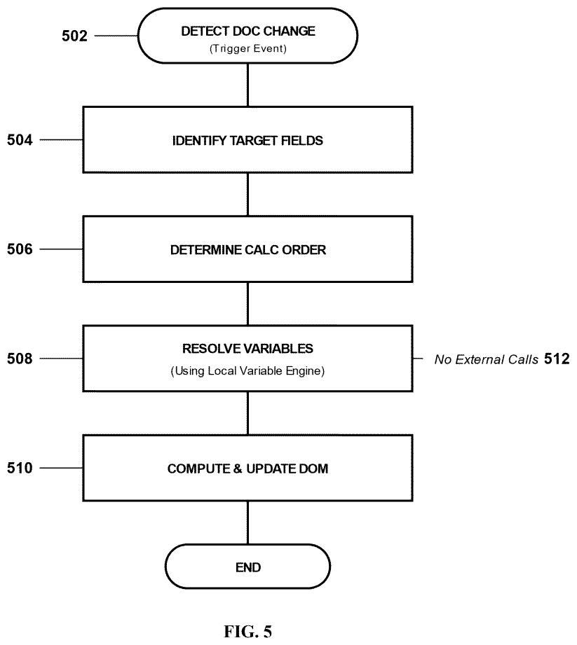

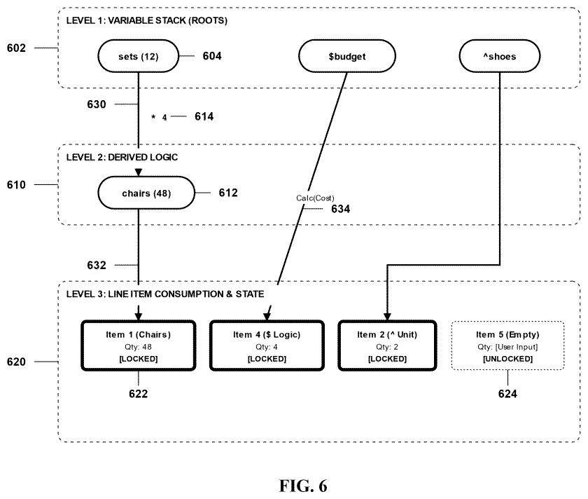

### 5. Local Logic Evaluation and Propagation (FIG. 5 & FIG. 6)

When a variable value changes (502), the system propagates updates to all dependent fields. The process includes Identifying target fields (504), Determining calculation order (506), Resolving variables using the Local Variable Engine (508), and Computing/Updating the DOM (510). Crucially, this process makes No External Calls (512).

FIG. 6 illustrates the propagation levels: Level 1 (Variable Stack roots like sets) (602) drives Level 2 (Derived Logic like chairs) (610), which in turn drives Level 3 (Line Item Consumption) (620).

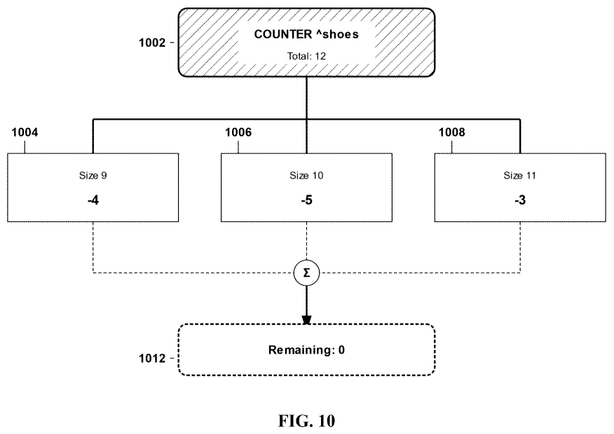

### 6. Counters and Allocation Behavior (FIG. 10)

Counters represented by $ or \hat{ }prefixes track consumption across multiple expressions. For example, a \hat{ }shoes counter (1002) tracks total available units (e.g., 12). Child items like “Size 9” (1004) and “Size 10” (1006) consume from this pool. The system sums the consumption (Sigma) and calculates the Remaining value (1012) locally.

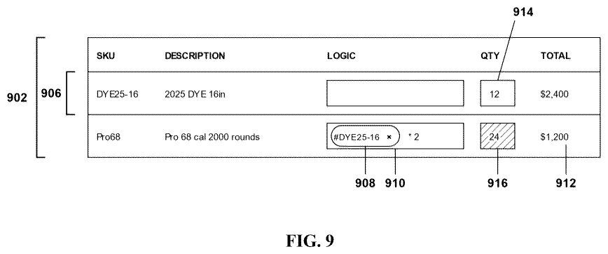

### 7. Target Markers for Structural Clarity (FIG. 9)

Target markers (~legs, ~seat, ~back, etc.) represent conceptual roles rather than numeric quantities. They are helpful when an assembly or configuration requires multiple components. For example, a user may create a line item labeled ~legs to represent the legs required for a chair. The target marker does not define the number of legs; instead, it marks this line item as fulfilling that requirement. A header variable such as chairs=10 may then be used in expressions to derive quantities (e.g., quantity=chairs * 4). Target markers improve readability, AI interpretation, and structural organization.

### 8. Sku Reference Behavior (FIG. 9)

Variables prefixed with #provide SKU-keyed local references within the single transactional document instance. In some embodiments, a #reference resolves to locally available SKU-related data, including (i) locally stored SKU metadata such as unit price or other item attributes and (ii) one or more fields of a line item identified by SKU (e.g., quantity, unit price, extended price) when such fields are stored within the document instance. This enables expressions to reference SKU-related values and/or line-item field values using #identifiers (e.g., #SomeSku. unitPrice, #SomeSku. qty) without requiring catalog synchronization, external inventory lookup, or cross-document linkage. For example, a line item representing a case of paintballs may be associated with a #paintballCase reference, enabling expressions such as: (1) quantity=players * 2, and (2) extendedPrice=quantity * #paintballCase. unitPrice.

In some embodiments, a #-prefixed identifier may reference a line item by specifying (i) a SKU and (ii) a referenced field of the line item stored within the single transactional document instance. For example, #Bat00z.qty resolves to the current quantity field of the line item having SKU Bat00z. This enables dependent line-item expressions in which a first line item drives a computed field of a second line item, such as quantity=#Bat00z. qty * 5, thereby causing a quantity of a second SKU (e.g., softball03) to be automatically computed as a function of the quantity of the first SKU (e.g., Bat00z) entirely within the single document instance, without external catalog lookup, cross-document synchronization, or enterprise governance.

If a #-prefixed identifier references a SKU that is not present in the single transactional document instance, the local evaluator returns a neutral value and/or generates a local validation alert indicating that the referenced SKU field cannot be resolved.

In some embodiments, when an expression includes a #-prefixed identifier that references a line-item field (e.g., #Bat00z.qty), the system records a dependency in the in-memory dependency graph from the referenced line-item field to the dependent expression, such that changes to the referenced field trigger automatic propagation and recomputation of dependent fields within the single transactional document instance, wherein the referenced line-item field is represented in the dependency graph as a resolvable identifier (e.g., Bat00z.qty) associated with the document instance.

All SKU metadata referenced via #pointers is strictly local to the document and does not involve catalog synchronization or enterprise item governance.

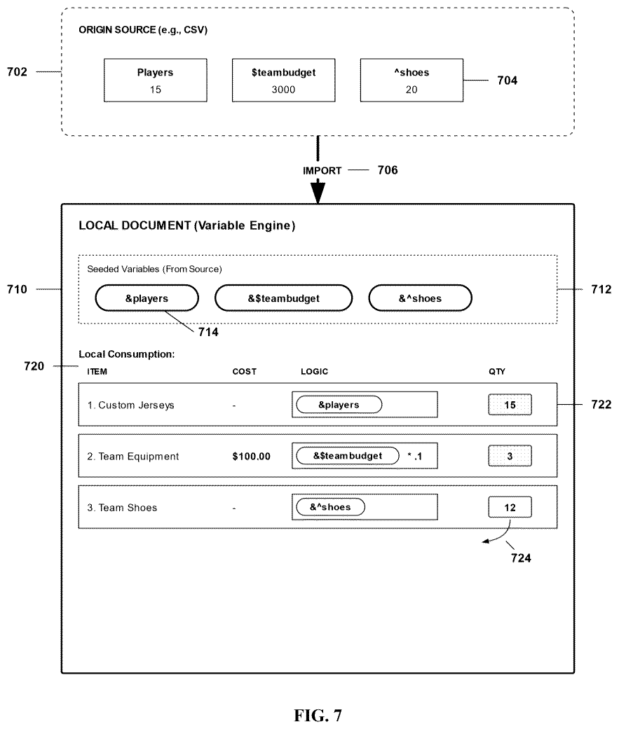

### 9. Structured Data Ingestion & “Seed Model” (FIG. 7)

A transactional document may be instantiated from an Origin Source (702) (e.g., CSV, JSON, EDI 850, or Template). This source contains structured data such as Players or \hat{ }shoes. Upon instantiation (Import 706), the data is ingested into the Local Document (710) as Seeded Variables (712) (e.g., &players, &\hat{ }shoes). These variables are now fully local; no ongoing link to the origin source is maintained, and modifications to the source after import do not propagate to the document. This Seed Model supports rapid configuration while avoiding enterprise-rule inheritance.

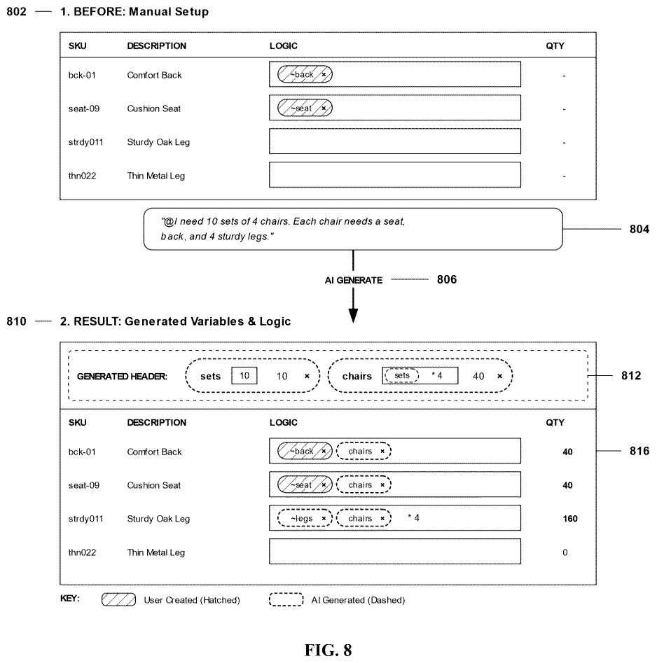

### 10. AI-Assisted Local Variable Interpretation (FIG. 8)

Users may enter natural-language instructions into a designated AI prompt field or by typing @ followed by descriptive text. The system's AI component interprets the text based solely on the local document content to propose:
New local variables,
Relationships between variables,
Structural target markers (~), or
Header-level multipliers (e.g., sets→chairs).
   Example: Input: “@I need 10 sets of 4 chairs. Each chair has 4 legs, 1 seat, and 1 back.” The AI may propose:
sets=10
chairs=sets * 4
~legs, ~seat, ~back target markers placed in corresponding line items.

The AI component analyzes line-item metadata and locally available data definitions (such as imported catalog snapshots) to resolve natural language adjectives (e.g., matching “sturdy legs” to “Sturdy Oak Leg” SKU).

### 11. Example Use Case (FIG. 9)

An order may include:
Header variable: players=20
Header variable: $budget=1500
Line item: #markerCase with quantity=players * 1
Line item: #paintballCase with quantity=players * 2
Counter: $budget showing remaining amount as line items consume value
Assembly structure markers: ~legs, ~seat, ~back for composite items.

Changing players triggers an automatic update across all referencing expressions. The system recalculates quantities, extended prices, and counter remainders without external logic.

### 12. Alternative Embodiments

The system may operate in browser-based, mobile, desktop, embedded, cloud-isolated, or edge device environments. Variations may include additional encapsulated logic visualizations, math functions, or expression templates, provided all logic remains localized to the document instance. External synchronization, enterprise policy enforcement, or global rule inheritance are explicitly excluded from this invention.

1. A computer-implemented method for enabling dynamic, variable-driven logic within a single transactional document instance, comprising: instantiating the single transactional document instance; storing local variables within the single transactional document instance; receiving an expression linking one or more of the local variables to one or more fields within the single transactional document instance; evaluating the expression locally to compute a result without reliance on external systems; and updating the one or more fields with the result, wherein at least one local variable includes a semantic identifier that alters evaluation behavior.

2. The method of claim 1, wherein the semantic identifier comprises a character or token indicating a specific logic role, such as a monetary pool identifier (e.g., $), an allocation counter identifier (e.g., \hat{ }), a SKU reference identifier (e.g., #), a structural target marker (e.g., ~), an AI prompt indicator (e.g., @), or an external seed import identifier (e.g., &).

3. The method of claim 2, wherein the semantic identifier indicates an allocation counter function (e.g., \hat{ }), and evaluating the expression includes updating a quantity in a line-item field while tracking consumption against a target value to enforce completeness.

4. The method of claim 2, wherein the semantic identifier indicates a monetary pool function (e.g., $), and evaluating the expression includes deducting from a remaining balance and preventing over-allocation.

5. The method of claim 1, wherein evaluating the expression includes parsing the expression into an abstract syntax representation.

6. The method of claim 1, wherein evaluating the expression includes determining an evaluation order based on dependencies among the local variables.

7. The method of claim 1, wherein updating the one or more fields occurs automatically upon a change to one or more of the local variables, without cross-document synchronization.

8. The method of claim 1, wherein the expression is constructed as a sequence of encapsulated logic tokens representing variables, literals, and operators as interactive graphical elements.

9. The method of claim 1, further comprising importing preconfigured variables from a structured data source, including but not limited to templates, EDI files, or JSON objects, without maintaining an ongoing dependency on the structured data source.

10. The method of claim 9, wherein modifications to the structured data source after importation do not propagate to the single transactional document instance.

11. The method of claim 1, further comprising: receiving a natural-language description from a user; generating, using a local AI assistant, one or more suggested variables or expressions based on content within the single transactional document instance; and incorporating the one or more suggested variables or expressions upon user approval.

12. The method of claim 11, wherein the local AI assistant operates exclusively within the single transactional document instance, without accessing external rules, policies, or templates.

13. The method of claim 6, wherein determining the evaluation order includes topological sorting of a dependency graph to ensure cycle-free evaluation.

14. The method of claim 11, wherein the local AI assistant is activated by a designated input field or prefix symbol within a logic field.

15. A system comprising one or more processors and a non-transitory computer-readable medium storing instructions that, when executed, cause the one or more processors to perform the method of claim 1.

16. A non-transitory computer-readable medium storing instructions that, when executed by one or more processors, cause the one or more processors to perform the method of claim 1.

17. The method of claim 2, wherein the semantic identifier indicates a SKU reference (e.g., #), and evaluating the expression includes: parsing an identifier that specifies (i) a SKU and (ii) a referenced field; retrieving, from within the single transactional document instance, a current value of the referenced field for a line item corresponding to the SKU; and using the current value as an input to compute a value for a field of a dependent line item.

18. The method of claim 11, wherein generating suggested variables or expressions comprises: analyzing the natural-language description to identify a requisite component; scanning line items for an existing structural target marker (e.g., ~) matching the requisite component; and, if the structural target marker is absent, analyzing line item descriptions to identify a best-match line item and automatically inserting the structural target marker into the best-match line item.

19. The method of claim 18, further comprising rendering the structural target marker in a first visual state if user-generated and a second, distinct visual state if automatically inserted by the local AI assistant to indicate origin.
